(19) United States
(12) Patent Application Publication
(10) Pub. No.: US 2002/0191268 A1
(43) Pub. Date: Dec. 19, 2002

(54) Variable multi-cavity optical device

(75) Inventors: James W. Seeser, Saint Louis, MO (US); Basil L. Swaby, Santa Rosa, CA (US)

Correspondence Address: SCOTT W HEWETT, 400 WEST THIRD STREET, #223, SANTA ROSA, CA, 95401

(73) Assignee: Optical Coating Laboratory, Inc, a Delaware Corporation, Santa Rosa, CA

(21) Appl. No.: 09/860,923

(22) Filed: May 17, 2001

(51) Int. Cl. G02F 1/03; G02B 6/35

(52) U.S. Cl. 359/260; 385/16; 385/140

(57) ABSTRACT

A multi-cavity optical device allowing selective control of a bandpass characteristic thereof . Fabry-Perot structures are coherently coupled together to form a narrow bandpass structure. At least one of the spacer regions in the device includes an active material that changes the optical thickness of the spacer to de-tune the device. In one embodiment, the active material is transparent and lies along the optical path through the device. In another embodiment, an active material that lies outside of the optical path tunes an air gap. Altering the first or last spacer in a multi-cavity structure provides variation in the transmission loss while generally retaining a flattop filter response with low passband ripple. Altering interior spacer regions provides high sensitivity to variations in the optical thickness of the spacer.

### STATEMENT REGARDING FEDERALLY SPONSORED RESEARCH OR DEVELOPMENT

Not applicable

### CROSS-REFERENCE TO RELATED APPLICATIONS

Not applicable.

### REFERENCE TO MICROFICHE APPENDIX

Not applicable.

### FIELD OF THE INVENTION

The present invention relates to optical devices. In particular, the present invention relates to multi-cavity Fabry-Perot type optical devices that preserve a passband shape while changing an active spacer region according to a control signal.

### BACKGROUND OF THE INVENTION

Optical filters of various kinds have been developed for a wide variety of technologies in order to transmit, absorb, or reflect desired wavelengths of light. For example, bandpass optical interference filters allow only a relatively narrow portion of the spectrum to pass there through, while blocking other portions of the spectrum by either reflection or absorption.

Very narrow bandpass optical interference filters, which pass only a very narrow band of light centered at a predetermined wavelength, have been developed for use in optical communications systems. Such optical filters are particularly useful in dense wavelength division multiplexing (DWDM) systems. In DWDM systems, narrow bandpass filters are employed along with erbium doped fiber amplifiers (EDFAs) that are used to boost the intensity of lightwave signals propagating over long distance signal mode fiber networks. Narrow bandpass filters are used to select specific wavelengths within the near infrared spectrum from many discrete wavelengths spread across the EDFA band. Such optical filters must have a very narrow pass band (e.g., about 1 nm or less at nominal center wavelength of about 1500 nm), and must be very stable with respect to environmental factors such as temperature and humidity. In addition, other amplifiers are being developed which will extend the band wavelengths available beyond the EDFA band.

Narrow bandpass filters are typically constructed of multi-layer designs deposited by processes that provide dense coatings having very good humidity properties and controlled stress. The coating materials and substrate combinations are chosen to have as a system, a low temperature coefficient, in order that the design is stable across the desired operating range. Typical coating designs embody the use of dielectric interference layers or stacks using materials of high refractive index and other materials of a low refractive index to produce mirrors or reflectors that surround one or more spacer layers or composite layers that serve the function of spacers.

The filter coating layers are designed to try and achieve a square-shaped transmittance pattern, of insertion loss versus wavelength for example, that is desirable for narrow bandpass optical filters. Each set of two mirrors and a spacer forms a cavity that transmits light at the selected wavelengths and essentially reflects light at the non-selected wavelengths, with transition regions commonly referred to as filter “skirts”. Generally, the more cavities a filter has, the more ideal the filter shape becomes; however, there is often a tradeoff in that the insertion loss may increase and the filters might be more difficult to fabricate. In particular, more cavities means more layers must be deposited, thus taking more time and adding expense. Also, in order to achieve the desired filter characteristic the cavities must be very closely aligned (matched) and stable. The alignment must be maintained at all temperatures or the optical properties of the filter might be lost if even one cavity drifts. Accordingly, much effort has been devoted to creating and maintaining this stability in narrow bandpass optical filters.

If the filter is not stable, the filter characteristic might change. For example, the center wavelength of the filter might change or additional modes in the filter structure may become active. Either type of change could result in inter-channel cross-talk or passband ripple. Undesirable cross-talk may occur if the selected channel interferes with adjacent channels, or if an adjacent channel(s) interferes with the selected channel. Passband ripple may result in an undesired wavelength-dependent insertion loss in the passband.

Thus, an optical channel or channels can be separated from a common DWDM signal using filters. However, different channels might have different signal levels. It is often desirable to adjust the amplitude of one channel with respect to another. This can be done in basically two ways. First, the weaker signal could be amplified to the level of the stronger signal. This involves a relatively expensive and complicated light amplifier (laser) with active components, such as a pump light source, that are prone to failure. Amplifiers typically also inject undesirable noise onto the signal.

Another way to adjust the relative amplitude is to attenuate the stronger signal to the level of the weaker signal. Various optical attenuators exist. Many optical attenuators are fixed attenuators, such as a length of lossy optical fiber. Other types are variable attenuators. One type uses a variable gray scale that is moved through the beam to absorb light. Other types use adjustable air gaps between collimators. Another type uses a tilting mirror to control the amount of light reflected from an input waveguide to an output waveguide. However, such complicated mechanical systems are generally undesirable because the moving parts are prone to wear.

Solid-state variable attenuators also exist. One approach uses variable polarization to achieve a variable decrease in light amplitude. Another approach displaces the center of the signal beam to de-couple an input from an output port. However, these techniques generally are broad-band techniques, and the attenuator is a separate component placed after any channel-separating filter.

Accordingly, it is desirable to provide a reliable optical bandpass filter that can also provide a selected amount of attenuation, and that can do so without disrupting adjacent channels.

### SUMMARY OF THE INVENTION

The present invention provides a narrow-band optical device with variable transmission loss. The device can be used as a variable-transmission element, a variable reflection element, or an element that transitions from reflective to transmissive, and vice versa. In a particular application, the device is used as a variable solid-state electronic optical attenuator, in another application the device is used as an optical switch.

The optical device is generally formed as a multi-cavity Fabry-Perot structure, or a series of optically coupled etalons. The term “Fabry-Perot structure” or “cavity”, as used herein, means two reflectors with an intervening spacer region that form a wavelength-selective optical structure. The reflectors can be dielectric stack reflectors, semiconductor layers, or metal thin-films, for example. Adjacent cavities are typically coupled through a coupling layer between two reflector structures. In other devices, a reflector between two spacer regions serves as a common reflector for each of the two cavities. The multi-cavity structure includes one spacer that is an “active” spacer that can be used to de-tune the structure. In one embodiment, the active spacer is the first or the last spacer in the multi-cavity structure. The optical length of the active spacer can be changed according to a control signal. In some embodiments physical length is changed, and in others the refractive index is changed.

The spacer region can be made of a single layer of material, or made of several layers of material. The change in the optical length of the active spacer region can be used to vary the transmission loss through the optical device while maintaining a characteristic passband shape. The control signal can be mechanical compression or tension, thermal, magneto-optic, an injected electric current, an applied electrical potential, or a light signal, for example. In one embodiment, the active spacer layer is a variable air gap; in another the active spacer material is a solid material such as a liquid crystal material, an electro-optic material, such as lithium niobate, or a polymer material.

In a particular embodiment, an optical device according to the present invention is used as a wavelength-selective switch in a wavelength division multiplexed (“WDM”) optical transmission system. A variation of about 0.5% in the optical length of the active spacer region of a five-cavity Fabry-Perot structure achieves a 20 dB change in the insertion loss of the multi-cavity filter structure while generally maintaining the passband shape. Side lobes are more than 50 dB down (−50 dB) from zero insertion loss 2 nm from a nominal center wavelength of 1550 nm. Thus cross-talk is minimal. The structure can be used as an attenuator or as a switch. The switch transitions from being essentially transmissive (i.e. having a transmittance of about 99.99%) to essentially reflective (i.e. having a transmittance of less than about 1%) over a change in thickness of a particular spacer layer of about 1%.

These and other features and advantages of the invention will be better understood by reference to the detailed description, or will be appreciated by the practice of the invention.

### BRIEF DESCRIPTION OF THE DRAWINGS

In order to more fully understand the manner in which the above recited and other advantages and objects of the invention are obtained, a more particular description of the invention briefly described above will be rendered by reference to a specific embodiment thereof illustrated in the appended drawings. Understanding that these drawings depict only a typical embodiment of the invention and are not therefore to be considered limiting of its scope, the invention will be described and explained with additional specificity and detail through the use of the accompanying drawings in which:

FIG. 1 is a simplified cross section of a multi-cavity optical device according to an embodiment of the present invention;

FIG. 2A is a graph showing the predicted transmittance characteristics of a device fabricated in accordance with the device shown in FIG. 1 for different amounts of change in the optical thickness of the first spacer region;

FIG. 2B is a graph illustrating the predicted shift in skirt response when the optical thickness of a spacer of the device of FIG. 2A is lengthened or shortened;

FIG. 2C is a graph showing the predicted transmittance characteristics of a device fabricated in accordance with the device shown in FIG. 1 for different amounts of change in the optical thickness of the second spacer region;

FIG. 2D is a graph showing the predicted transmittance characteristics of a device fabricated in accordance with the device shown in FIG. 1 for different amounts of change in the optical thickness of the middle spacer region;

FIG. 3 is a graph illustrating predicted attenuation versus cavity manipulation for a device according to an embodiment of the present invention;

FIG. 4A is a simplified graph showing the predicted transmittance of a six-cavity device according to an embodiment of the present invention as the fifth cavity is manipulated;

FIG. 4B is a simplified schematic representation of the layer structure of the device modeled in FIG. 4A;

FIG. 5A is a simplified cross section of two portions of a multi-layer optical device before assembly;

FIG. 5B is a simplified cross section of the two portions of the multi-layer optical device shown in FIG. 5A after the two portions are joined together;

FIG. 5C is a simplified cross section of a multi-cavity optical device with a tunable air gap according to another embodiment of the present invention;

FIG. 6A is a simplified diagram of an optical system according to an embodiment of the present invention;

FIG. 6B is a simplified top view of an electrode for inclusion in an optical device according to an embodiment of the present invention;

FIG. 7A is a simplified flow chart of an attenuation process according to an embodiment of the present invention; and

FIG. 7B is a simplified flow chart of a switching process according to an embodiment of the present invention.

### DETAILED DESCRIPTION OF THE INVENTION

1. Introduction

The present invention is directed to a multi-cavity optical bandpass device that is particularly useful in optical communication systems, such as in dense wavelength division multiplexing systems. The device of the present invention provides the ability to control the transmission of a selected channel or segment of the spectrum such that the filter can be in an “off” condition to prevent transmission or in an “on” condition to allow transmission of a particular wavelength. The device can also operate in intermediate conditions to provide a selected amount of attenuation to the transmitted or the reflected signal.

In a multi-cavity structure, the cavities typically coherently interact with one another. Much effort has gone into making such multi-cavity structures stable. It is similarly desirable that the initial configuration of the cavities according to embodiments of the present invention also provide the desired interaction, and that non-active cavities remain stable. However, one cavity in the stack is intended to be tunable, in other words, one cavity in the stack can be altered to de-tune the entire multi-cavity structure. In one embodiment, this de-tuning is accomplished in such a way as to preserve the generally flat-top filter shape, and without sidebands or side lobes rising to affect inter-channel cross talk.

2. Multi-cavity Filter Devices

Optical filter devices according to the present invention are fabricated by conventional coating techniques where materials having different refractive indices are generally deposited in an alternating sequence on a substrate. The substrate could be glass, plastic, semiconductor, or dielectric crystal, among others, depending on the intended application including the nominal optical wavelength(s) of the device. Typically, the reflectors in the cavities are formed by depositing alternating layers of materials having high and low indices of refraction (relative to each other), each layer having a physical thickness that provides an optical thickness of about a quarter-wavelength of the center wavelength of the device.

Some coating designs for the optical filter use interference layers or stacks of high and low refractive index materials to produce reflector layers on either side of one or more spacer layers. In other designs a very thin layer of metal, such as gold, is used in the reflector. The invention provides a filter device in which the optical properties of the filter can be affected by changing the optical thickness of selected layers in order to detune the filter in a controlled fashion that preserves the bandpass shape while changing the insertion loss through the filter. The optical thickness of the spacer region can be altered as a result of any one or combinations of changes in the physical length, index of refraction, absorption, or scatter.

Generally speaking, the devices are reciprocal two-port devices. A light signal arriving at one port can be transmitted to the second port, reflected off the first port, or absorbed in the device. Those skilled in the art will appreciate that it is the signals that are usually measured at the ports, and that the actual physical mechanism of transmission, reflection, and absorption can take place throughout the device.

As used herein, the term “optical thickness” refers to the physical thickness of the optical layer multiplied by the refractive index of the material composing the optical layer. Thus, the optical thickness can be represented by the product nd, where n is the index of refraction of the optical layer material and d is the physical thickness of the optical layer. Applying a control signal to the active spacer material changes the optical thickness of the active spacer region in a controlled fashion to de-tune the multi-cavity structure. Various types of control signals are possible. For example, a control signal in an air-gap device might be an electric voltage applied to a piezoelectric transducer that moves the reflectors of the active cavity closer together or further apart.

If the active spacer includes an active air gap or electro-optic material, applying a voltage across that material may serve as the control signal. An example of an electrically tunable optical filter utilizing a deformable multi-layer mirror is provided in U.S. Pat. No. 5,739,945 by Tayebati, issued Apr. 14, 1998. Suitable electro-optic materials include various organic polymer materials such as liquid crystals, electro-chromic materials such as tungsten oxide (WO₃), and other inorganic electro-optic materials such as lithium niobium oxide (LiNbO₃) and potassium dihydrogen phosphate (KDP). Various combinations of these materials may also be utilized in forming the active spacer layers. Suitable transparent conducting electrodes can be made from transparent conductive materials such as indium oxide, indium tin oxide (ITO), doped semiconductors (e.g., boron-doped SiO₂), combinations thereof, and the like, and are used to apply the electric field. Alternatively, metallic electrodes may be used. The metallic electrodes may be very thin, causing a minimal, yet acceptable, increase in insertion loss, or may be shaped, such as in the shape of an annulus, to pass light through the center, while providing the desired electric field gradient. Similarly, if the active spacer includes a semi-conductor material whose refractive index changes with current injection, the control signal might be a current supplied to the active material through shaped electrodes.

Other types of mechanisms, such as thermo-optic effects, might be used. In the case of a thermo-optic active spacer, the active material might expand and contract, thus changing the physical length, as well as or alternatively to changing the refractive index of the material over temperature. Suitable thermo-optic materials for formation of spacer layers to be manipulated according to the present invention include various organic polymer materials such as polyimide, and liquid crystals, as well as various inorganic materials such as silicon, germanium, and ferric oxide (Fe₂O₃), where the index of refraction is sensitive to temperature in the wavelength region of interest. Various combinations of these materials may also be utilized in forming the spacer layers for manipulation. Optical layers composed of these thermo-optic materials have a change in their index of refraction or optical thickness when subjected to a temperature change.

Generally, it is desirable that the remainder of the multi-cavity structure remains stable over temperature. This can be addressed by using materials that are relatively stable over temperature, such as silicon dioxide (SiO₂), titanium oxide (TiO₂), and tantalum oxide (Ta₂O₅), as well as using temperature compensation or stabilization techniques, of which several examples are known.

In yet another embodiment of the invention, a magneto-optic material(s) is used in the active spacer. Such a cavity can be pre-tuned, with a permanent magnet, for example, and an electromagnet can add to or subtract from the initial magnetic field. Alternatively, an electro-magnet can be used to selectively alter the optical length of the active layer that includes an electro-optic material. A magnetic liquid crystal is one example of a possible material for use in a magneto-optic active spacer.

In yet another embodiment of the invention, the active layer of the filter device includes a photorefractive material. A photorefractive material is one in which the refractive index changes with exposure to light. Thus, to produce a photorefractive effect, a light beam at a wavelength different than the wavelengths over which the filter device is expected to switch or reflect is incident, such that the energy of the light beam is absorbed by the active material of the critical layers in a manner that changes the refractive index of the active material.

It is generally desirable in each of the above embodiments that the passband shape of the filter, attenuator, or other device would not change shape, other than to vary the insertion loss, and would not shift in frequency. It was found that such operation can be obtained with a relatively small, in some cases as little as 0.5-1%, change in the optical thickness of certain spacer layers in multi-cavity structures. By causing a small change in the critical layers with the selected manipulation, the optical filter can be smoothly changed from being a high transmitter to a high reflector and vice versa in a reciprocal fashion.

3. Modeling Results

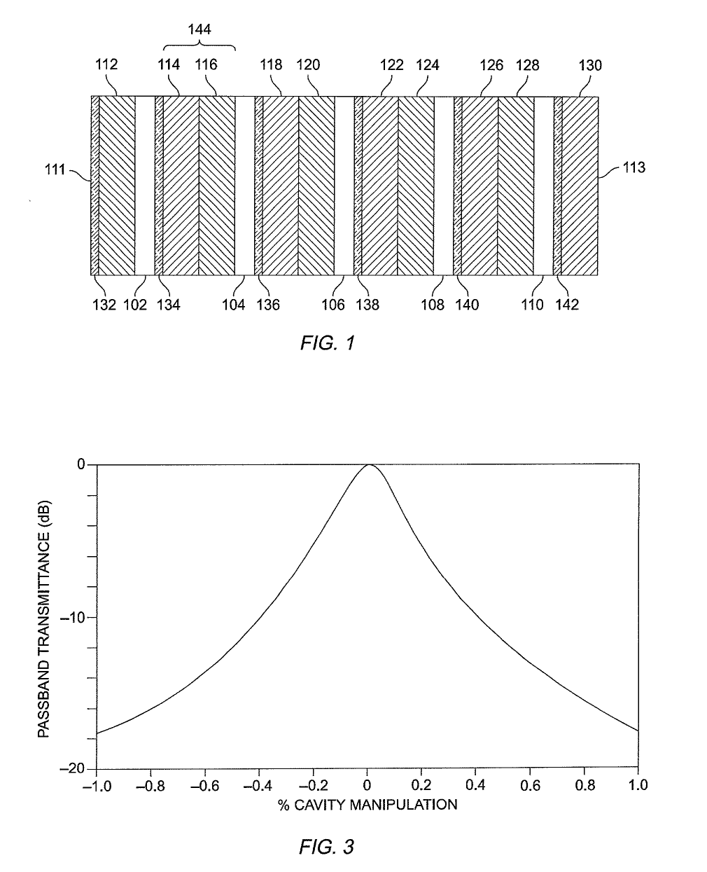

FIG. 1 is a simplified representation of a multi-cavity filter structure 100 according to an embodiment of the present invention. The term “filter” is used herein to conveniently describe various structures that may be employed in a variety of functions, such as switches and attenuators, and not merely devices that operate solely as filters. The structure includes five spacer regions 102, 104, 106, 108, and 110.

Each spacer region can be formed from a single layer of material (“monolithic”), or from multiple layers of a material, or from layers of different materials. In this model, the first 102 and last 110 spacers have an optical thickness of four times the center wavelength (1550 nm) (i.e. sixteen times the quarter-wave optical thickness or “QWOT”), the second 104 and fourth 108 spacers have an optical thickness of eight times the center wavelength, and the middle spacer 106 has an optical thickness twelve times the center wavelength. The thicknesses and relative thicknesses of the various layers and regions are exemplary, and many other configurations are possible.

The structure also includes ten reflector stacks 112, 114, 116, 118, 120, 122, 124, 126, 128, 130 one on each side of the spacer layers. For purposes of modeling, each reflector stack includes seven pairs of alternating layers of high (“H”) index of refraction (herein after “index”) material and low (“L”) index material, each layer having an optical thickness of a quarter wavelength. An additional low-index layer 132 is added on the end of the device, and additional low-index layers 134, 136, 138, 140, 142 are added between the high-index spacer regions and the first high-index layer(s) of the H-L pairs in the reflector stacks.

Other types of reflector stacks and other types of reflectors could be used in an actual device. The “first” Fabry-Perot structure is arbitrarily chosen as the one nearest the input 111 of the device, and the “last” Fabry-Perot structure is nearest the output 113. The inner reflector stacks are back-to-back or “continuous”, essentially being a 14-layer reflector structure 144 between spacer regions 102, 104. Additional coatings could be added, such as anti-reflection coatings. The total physical thickness of the L layers is 20,401.8535 nm with a total quarter-wave optical thickness of 118330.7188 nm, the total physical thickness of the H layers is 18183.0000 nm with a quarter-wave optical thickness of 158555.8594 nm, and the initial physical thickness of the active region is 711.0092 nm, with a quarter-wave optical thickness of 6,2000.000 nm. Hence, the total physical thickness of the layers would be about 39,296 nm (1.54 mils). The substrate index was chosen as 1.52, which is appropriate for a glass substrate, and the angle of incidence was perpendicular to the surface from an air medium of quasi-infinite thickness. Other models would be appropriate for other optical systems, such as non-air coupling, non-glass substrates, or direct coupling from waveguides to a multi-cavity device with index-matching compound.

Examples of suitable materials having a relatively high index of refraction include tantalum oxide, titanium dioxide, silicon, germanium, gallium arsenide (GaAs), indium phosphide (InP), combinations or mixtures thereof, and the like. Suitable materials having a relatively low index of refraction include silicon dioxide such as fused silica, aluminum oxide, doped semiconductors, combinations or mixtures thereof, and the like. The reflector and spacer sections are formed of multiple quarterwave layers set at a desired wavelength. The spacers or cavities generally have the effect of changing the filter pass band and changing the optical phase thickness.

For modeling purposes, the low index was defined as 1.45, representative of silica, for example, and the high index was defined as 2.18, representative of tantalum oxide or similar materials. These numbers were chosen for purposes of illustration only. Other indices would be appropriate for other materials. Similarly, there is no requirement that each L layer be of the same material or have the same index, with the same being true of the H layers. The reflector stacks may have more or fewer layers, and the optical device more or fewer cavities, depending on the degree of ideality desired to be obtained. For convenience of discussion, the center wavelength is used as the standard wavelength when talking about half-wavelength or quarter-wavelength, for example. A center. wavelength of 1550 nm was chosen for modeling purposes because many optical communication systems operate at around this wavelength; however, this wavelength is merely exemplary.

The spacer layers are generally chosen to have an optical wavelength of an integer multiple of a half-wavelength. In one calculation, each spacer layer was modeled as having an optical thickness of four wavelengths. A spacer material having a high (2.18) index was chosen for simplicity of modeling, but a low-index or intermediate-index spacer material could be used. A high-index material was initially chosen for the active spacer material because it was believed that a high-index material might provide a greater range or sensitivity in tuning the optical length of the active spacer region.

The results presented below were obtained on a computer using thin-film optical filter modeling software, of which several versions are commercially available. Examples include OPTILAYER, available from Gary deBell of Los Altos, Calif., and similar programs available from SOFTWARE SPECTRA, INC., of Portland, Oreg. It is believed that structures according to the examples used for modeling are manufacturable in light of multi-cavity filter structures having more than five spacer regions that have been fabricated. Transmission monitoring during layer deposition may facilitate the manufacturing of multi-cavity thin-film structures.

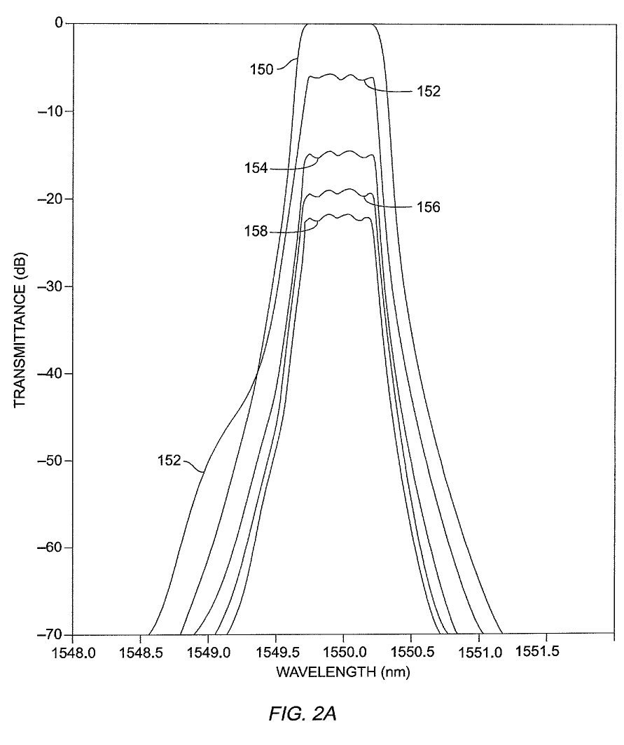

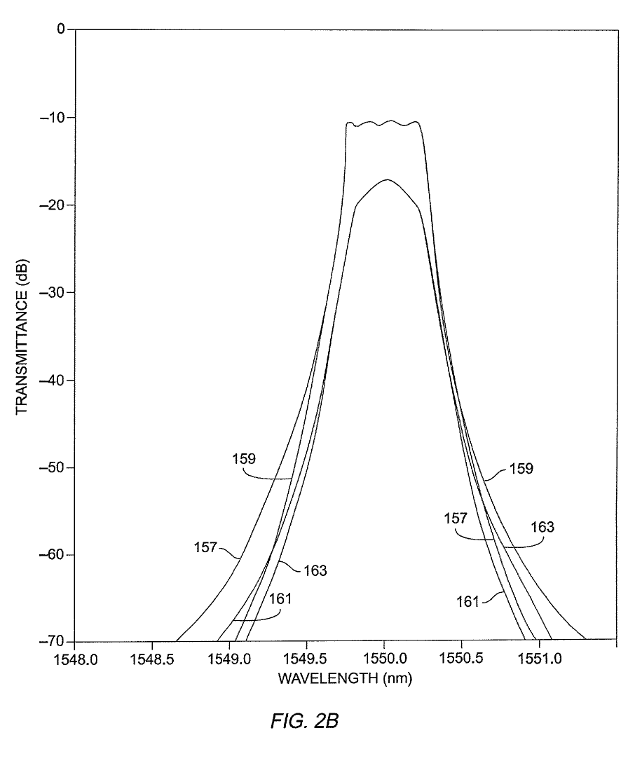

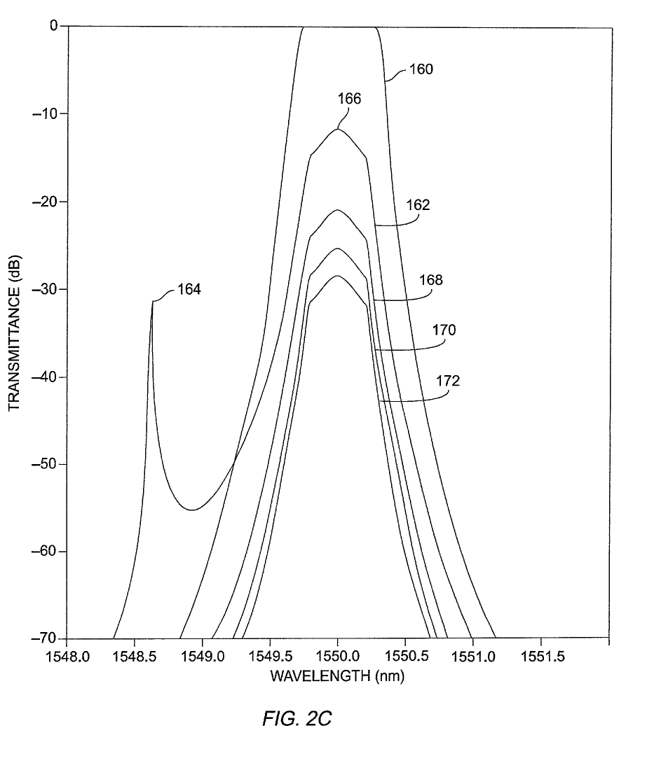

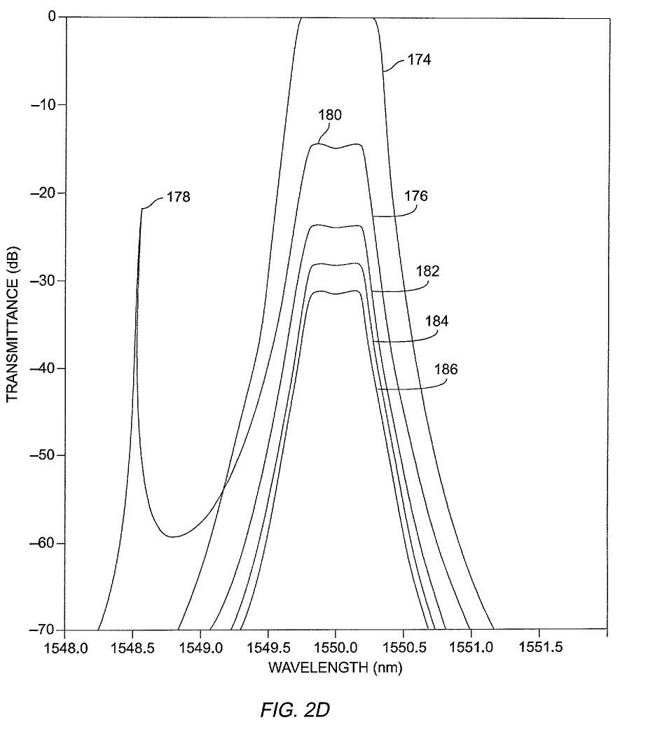

FIG. 2A is a simplified representation of the predicted transmittance of a preferred five-cavity structure according to the present invention in accordance with FIG. 1 for various active spacer lengths. In this instance, the first spacer region (FIG. 1, ref. num. 102) was varied; however, the device is reciprocal, and essentially the same results were obtained by varying the length of the last spacer region (FIG. 1, ref. num. 110). The active spacer region has an optical thickness of four quarterwaves at the design nλ₀, and is referred to as a fourth-order spacer. A fourth-order spacer is merely exemplary and spacers of other thickness could be used.

The first trace 150 is the transmittance of the five-cavity structure with the initial one-wavelength length of the active spacer region. The second trace 152 is the transmittance of the structure when the QWOT of the first spacer is reduced from 6200 nm to 6192.2407 nm or about 0.25%. The third trace 154 is the transmittance when the optical length is reduced to 6176.7212 nm or about 0.5%, the fourth trace 156 is the transmittance when the optical thickness is reduced to 6161.2017 or about 0.75%, and the fifth trace 158 is the transmittance when the optical thickness is reduced to 6145.6821 or about 1.0% from the original optical thickness, obtaining about 20 dB attenuation. A similar effect is achieved by increasing the thickness the same relative amount. The magnitude of attenuation is the same; however, the slopes shift in opposite directions (depending on a −0.25% shift or a +0.25% shift, for example.

FIG. 2B is a simplified graph illustrating the shift in the slope for a −0.25% change in the first spacer 157 and for a +0.25% change in the first spacer 159 of the five-cavity structure illustrated in FIG. 2A. The shift in changing the second or fourth spacer 0.25% 161 and +0.25% 163 is also shown. Thus, a 1.0% change in the optical thickness of this spacer region results in about 22 dB difference in insertion loss (transmittance). Furthermore, the structure maintains a desirable “flat-top” or “square” shape, with only about 2 dB of ripple in the center of the passband, even as the transmittance is decreased. The center frequency, computed from the half-power points, was 1550 nm for all five traces.

FIG. 2C is a simplified representation of the predicted transmittance of the five-cavity structure illustrated in FIGS. 1 and 2A for various active spacer lengths when the second spacer (FIG. 1, ref. num 104) is the active spacer. The second spacer is twice as thick as the first spacer. Essentially the same results were obtained when the fourth spacer was modeled as the active spacer. The first trace 160 is the transmittance with the initial full-wavelength spacer length. The second trace 162 is the transmittance when the optical thickness of the spacer is reduced from 12400.0010 nm to 12384.4805 nm, or about a 0.25% change in spacer length. Note the side lobe 164 rising to within about −16 dB of the peak transmittance 166. Although varying the second or fourth spacer region provides greater sensitivity and range of transmittance for similar changes in the optical length of the spacer, the passband ripple has increased to about 4 dB. Similarly, the side lobe is undesirable in most telecommunication systems because it could allow inter-channel crosstalk. In other words, an optical signal present on another channel with light at about 1548.6 nm could be passed through the device with only about 16 dB suppression below the selected channel.

The third trace 168 represents a decrease in the optical thickness of the second spacer to 12353.4404 nm, or about a 0.5% change in the optical thickness of the active spacer region. Note that the center of the passband is also peaked. Such variation in transmittance within the pass band can cause problems such as uneven amplification of an optical signal transmitted through the structure, which could require gain flattening or compensation. The fourth trace 170 represents a decrease in the optical thickness of the second spacer region to about 12322.4033, or about a 0.75% change in the optical thickness of the active spacer, and the fifth trace 172 represents a decrease in the optical thickness of the second spacer region to 12291.3643 m, or about 1.0% change in the optical thickness of the active spacer. When the optical thickness of the first (or fifth) spacer region is varied 1.0%, the transmittance drops about 22 dB. In comparison, when the optical thickness of the second (or fourth) spacer region is varied 1.0%, the transmittance drops about 28 dB. Thus, greater sensitivity of the transmittance to variations in the second or fourth spacer region can be obtained; however, varying this region produces increased ripple in the band and a generally undesirable sidelobe.

FIG. 2D is a simplified representation of the predicted transmittance of a five-cavity structure according to the present invention for various active spacer lengths when the third, or center, spacer (FIG. 1, ref. num 106) is the active spacer. The first trace 174 is the transmittance with the initial full-wavelength spacer length. The second trace 176 is the transmittance when the optical thickness of the center spacer is reduced from 18600.0020 nm to 18576.7188 nm, or about a 0.25% change in spacer length. Note the side lobe 178 rising to within about −8 dB of the peak transmittance 180. This side lobe is even more pronounced than the side lobe in FIG. 3; however, the peak frequency of the side lobe has shifted to a shorter wavelength compared to the side lobe shown in FIG. 3. In some instances, such as when additional filters remove optical signals that the side lobe might otherwise transmit, multi-cavity devices wherein a spacer region other than the first or last spacer region is varied might be appropriate for practical use. One such use might be in a filter cascade, where a filter centered at 1548.5 nm, for example, passes essentially all the light in that band through the filter before the remaining light signals are provided to the structure represented by FIG. 2D.

The third trace 182 represents the expected transmittance when the optical thickness of the center spacer region has been reduced to 18530.1602 nm, or about a 0.5%, the fourth trace 184 represents the expected transmittance when the optical thickness of the center space is reduced to 18483.6035 nm, or about a 0.75% change, and the fifth trace 186 represents the expected transmittance when the optical thickness of the center spacer region is reduced to about 18437.0488 nm, or about a 1.0% change. Varying the center spacer 1.0% results in about 32 dB difference in transmittance. Note that the center of the passband remains relatively and smooth while the transmittance is varied. Thus, varying the center spacer region may be desirable when a large difference in transmittance, or high sensitivity to variations in the optical length of the spacer region, is desired, assuming that the sidelobe is acceptable.

FIG. 3 is a graph of attenuation versus cavity manipulation for a five-cavity filter wherein the fifth cavity is manipulated to vary its optical length.

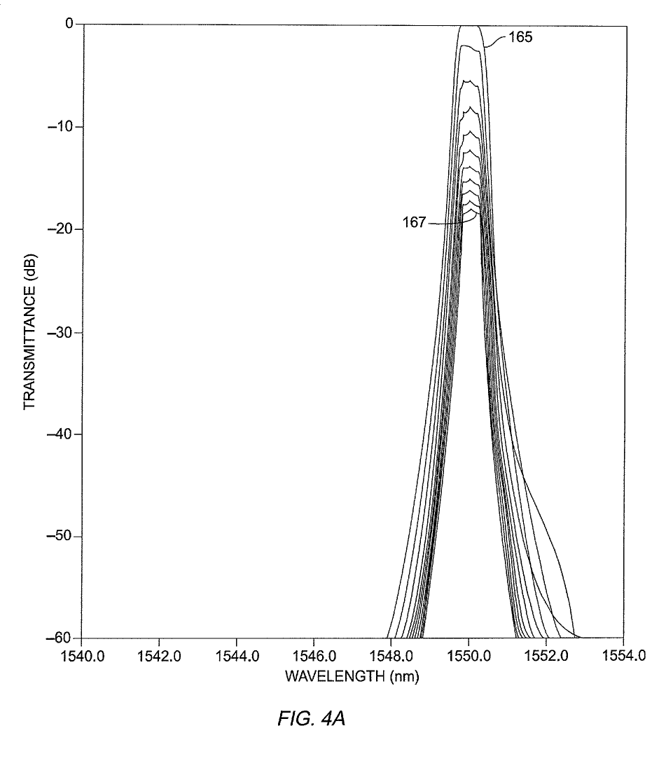

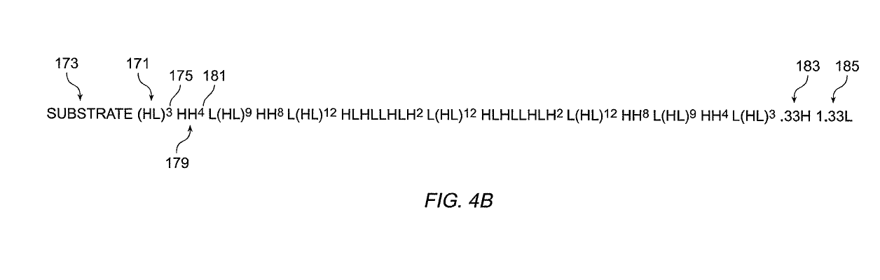

FIG. 4A is a simplified graph showing the predicted transmittance of a six-cavity device as the fifth cavity is manipulated. Similar results are obtained if the second cavity is the active cavity and manipulated in a similar fashion. In this model, the fifth cavity is an air cavity, with the nominal air gap being 6.2 microns long for a total QWOT of 24800. Increasing (or decreasing) the air gap can vary the transmittance from essentially 0 dB to −20 dB while maintaining full width half-maximum integrity and unperturbed out-of-band attenuation. The first trace 165 is the transmittance of the structure with the initial 6.2 micron air gap. The successive traces represent successive decreases of 0.1% in the optical length of the air gap. The last trace 167 is the transmittance of the structure with a 1.0% decrease in the length of the air gap.

FIG. 4B is a representation of the layer structure of the six-cavity structure of FIG. 4A. The designations “H” and “L” stand for quarter-wave layers of high- and low-index of refraction material. When a layer pair is raised to a power, that indicates the number of times those layer pairs are repeated. For example, the HL pair 171 next to the substrate 173 is repeated three times, as indicated by the exponent 175, and the layer pair HH 179 (representing a half-wave structure) is repeated four times, as indicated by the exponent 181. Thus, HH⁴ indicates eight quarter-wave optical thicknesses of the high-index material. The partial high-index layer 183 and greater than unity low-index layer 185 are provided on the end of the stack for matching to the medium, which is this model is air.

This layer stack produces a structure with an effective index of refraction that is not the same as one of the layer materials. A high-index 183 and a low index 185 anti-reflection layers are added on the stack to improve matching to ambient air. The high-index anti-reflective layer is 0.33 times the thickness of the other high-index layers (“H”) and the low-index anti-reflection layer is 1.33 times the thickness of the other low-index (“L”) layers. The software models the layers according to their relative indices of refraction, hence the air gap, which is given an approximate relative index of refraction of “1”, is not shown as a layer in the stack. The total physical thickness of the high-index material is 19800.9316 nm, with a QWOT of 167911.8125 nm. The total physical thickness of the low-index material is 22253.9531 nm with a QWOT of 129161.9688 nm, and the total physical thickness of the air spacer is 6200.0000 nm with a QWOT of 24800.0000 nm.

4. Exemplary Structures

In alternative embodiments of the invention, filter devices can be fabricated without the use of an underlying substrate. For example, a bulk piece of thin material such as LiNbO₃ could be utilized on which the other optical layers are deposited, with the thin material acting as one of the cavities.

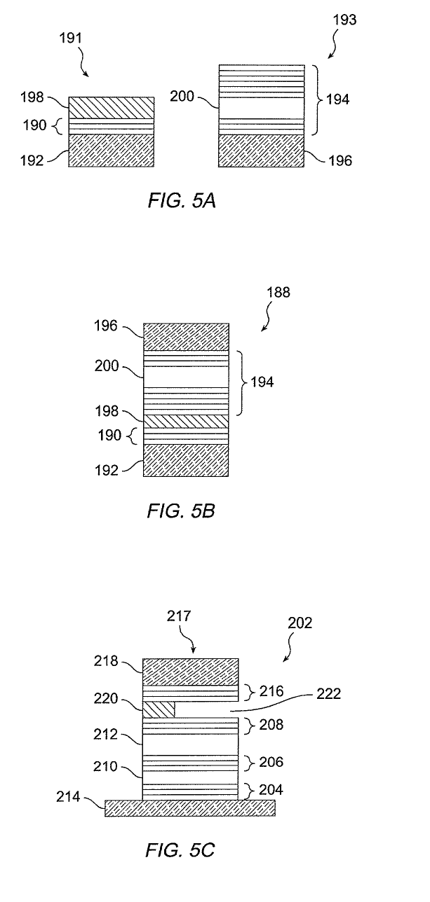

FIG. 5A is a simplified cross section of portions 191, 193 of another alternative embodiment of a multi-cavity structure in which a first set of thin-film optical layers 190 are formed on one substrate 192 and a second set of optical layers 194 are formed on a second substrate 196. One set of optical layers could include a series of deposited thin films, with the final layer 198 being formed by epitaxy, chemical vapor deposition, or other process. FIG. 5B shows the two coated substrates 192, 196 bonded together using conventional flip-chip processes to form an overall multi-cavity optical structure 188 with the epitaxial-grown layer, for example, being a spacer region within the multi-cavity structure. Other spacers 200 could be deposited as a thin-film layer or layers. This technique has the advantage being able to use layers of materials that are not easily vacuum-deposited as a thin film, such as some semiconductor materials.

FIG. 5C is a simplified cross section of an optical device 202 according to another embodiment of the present invention. A first optical stack of reflectors 204, 206, 208 and two thin-film spacers 210, 212 are formed on a first substrate 214. A reflector 216 has been formed on a second substrate 218 and coupled to the first stack with a layer of mechanically active material 220 leaving a gap 222 between the two thin film stacks. The mechanically active material is a material that changes dimension along the direction perpendicular to the thin film layers and lies outside of the optical signal path, represented by an arrow 217. For example, the mechanically active material could be a piezoelectric material that changes dimensions in response to an applied electric field, or a material that expands or contracts in response to a selected and controlled change in temperature, or a magneto-strictive material that expands or contracts according to an applied magnetic field. In other embodiments, the mechanically active material may includes several layers of material or materials, and different layers of material might respond to a different stimulus.

The second substrate 218 holds the reflector 216 in a rigid orientation to the next reflector 208 in the optical path (which is normally essentially perpendicular to the thin film layers). Additional features, such as electrodes on opposite faces of the mechanically active material are not shown for simplicity of illustration. Providing the cantilevered support for the movable reflector 216 and a gap 222 allows use of mechanically active materials that are not transparent. This provides a wide variety of materials to choose from, including materials with sufficient range of change in dimension that fabricated devices can be tuned to the initial operating point, with sufficient range left over for active tuning to vary the transmittance. For example, the active material might include a layer of magneto-strictive material and a layer of piezoelectric material (with electrodes). A permanent magnet might be brought into proximity to the magneto-strictive material to tune the device for low initial insertion loss and fixed in place. Then, the insertion loss can be selectively varied using the piezoelectric material to de-tune the gap. In alternative embodiments, the gap is filled with a liquid or gas, such as air or nitrogen. The cantilevered section is shown as having only a single reflector; however, other layers and cavities could be formed on the cantilevered section, as the thin films are typically very thin and light.

5. An Exemplary Optical System and Applications

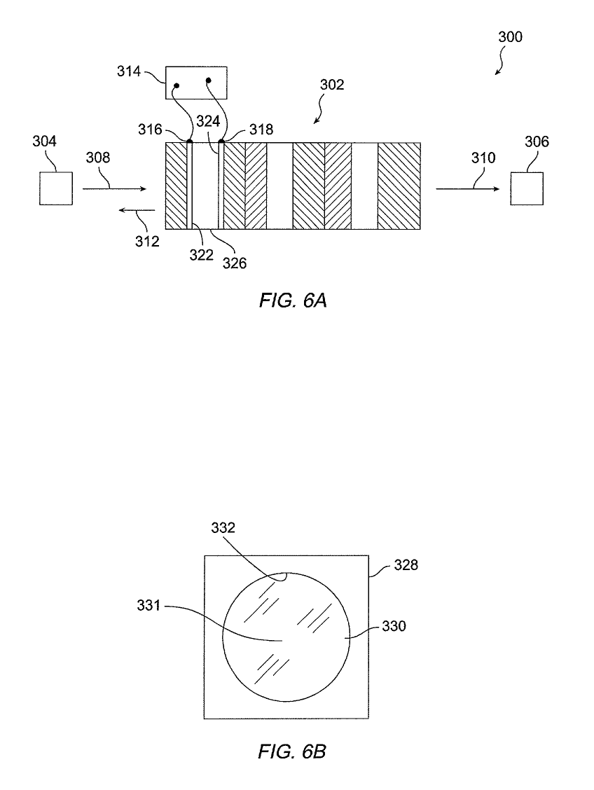

FIG. 6A is a simplified diagram of an optical system 300 according to an embodiment of the present invention. A multi-cavity optical device 302 according to the present invention is placed between a light source 304 and a light receiver 306. A portion of the input light beam, represented by the arrow 308, passes through the optical device, as represented by the arrow 310. A remainder of the input light beam, represented by the arrow 312, is reflected off of the device, which could be a three-port device. The remainder could be coupled to another output port through an optical isolator (circulator) or to an optical fiber through a gradient-index (“GRIN”) lens that focuses the reflected remainder onto the end of the optical fiber. In one application, the multi-cavity device operates as a variable optical attenuator, transmitting a selected amount of the light signal through the device according to the control signal. In another application, the multi-cavity device operates as an optical switch, transitioning from an essentially transmissive state to an essentially non-transmissive reflecting state upon application of a control signal.

A power supply 314 provides a control signal to electrodes 316, 318 that couple the control signal to an active spacer region 320. The active spacer region could be a solid layer(s) or include a variable air gap, as discussed above in relation to FIG. 5C. In one embodiment, optically transparent conductive layers 322, 324, such as indium-tin-oxide layers, distribute an electric potential across the surface of a piezoelectric spacer layer 326. In another embodiment, the power supply is a light source that illuminates the active spacer region. In yet another embodiment, the spacer layer is a semiconductor material that is transparent at the selected wavelength and the power supply is a current source.

FIG. 6B is a simplified top view of an electrode 328 formed on a transparent spacer material 330. A similar or different electrode can be formed on the opposite surface of the spacer material. Current is injected into the center 331 of the active material from the perimeter 332 and adjoining surface of the electrode. The light beam passes through the clear center of the electrode. In an alternative embodiment, the electrodes are on surfaces of the active spacer material lying essentially parallel to the optical beam path, out of the optical beam path.

6. Exemplary Processes

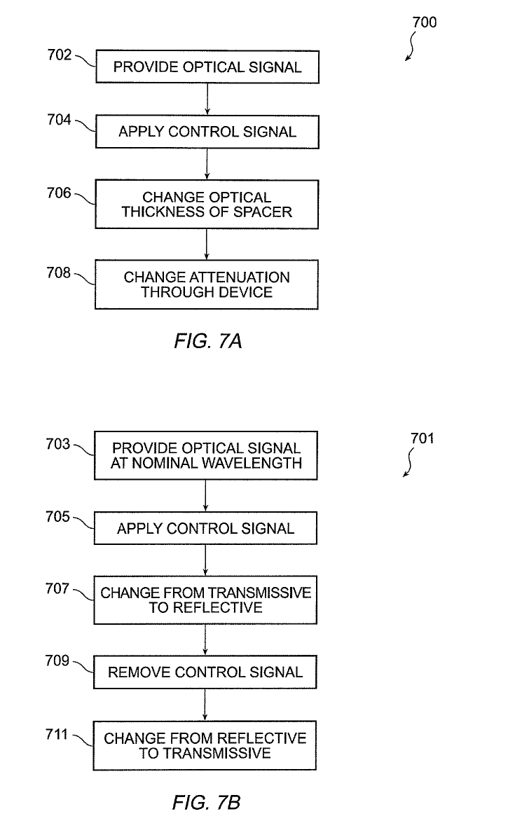

FIG. 7A is an optical signal attenuation process 700 according to an embodiment of the present invention. An optical signal at a nominal wavelength is provided to a multi-cavity optical device that has an active spacer (step 702). A control signal is applied (step 704) to the active spacer to change the optical thickness of the optical spacer (step 706). Changing the optical thickness of the active spacer changes the transmission loss of the optical signal through the multi-cavity optical device (step 708). In one embodiment the de-tuning increases transmission loss, in an alternative embodiment, the initial state of the device is a high-loss state and the active spacer is changed to reduce the transmission loss through the device.

FIG. 7B is an optical switching process 701 according to an embodiment of the present invention. An optical signal at a nominal wavelength is provided to a multi-cavity optical device (step 703). A control signal is applied to change the optical thickness of an active spacer material of the multi-cavity optical device (step 705), which changes the device from an essentially transmissive state to an essentially reflective state (step 707). The device can be cycled by removing the control signal (step 709) to transmit the signal through the device (step 711) again.

In a particular embodiment, the multi-cavity device is a narrow-band device having a relative bandwidth (½ power width/center wavelength) of about 0.04% and changes from having a transmittance of about 99.99% to a transmittance of about 0.74%. The transmittance of a physical device might have a high transmittance of between about 85-95%. A device having a high transmittance of about 85% can be useful in a number of applications, such as switches or attenuators. A device having a high transmittance of about 90% provides improved high transmittance and reasonable manufacturing yields. A device having a high transmittance of about 95% achieves very high transmittance, accounting for transmission losses that arise due to manufacturing variations, media transitions, such as from a optical fiber to an optical beam in free space, and non-ideality of the F-P structure, which might approach 99% transmission.

“Application” of a control signal could mean the removal of a stimulus. For example, the device could be heated to maintain high transmittance, and the heat turned off or removed to convert the device to a reflective state. Generally, the multi-cavity devices can be cycled from one state to the other very many times, and the transition from reflective to transmissive is smoothly variable, as shown above by the family of curves in FIG. 2, for example.

The present invention may be embodied in other specific forms without departing from its spirit or essential characteristics. The described embodiments are to be considered in all respects only as illustrative and not restrictive. For example, embodiments have been generally described in which a control signal is applied. Alternatively, the control signal could be removed to achieve the tuning or de-tuning of the multi-cavity device. The scope of the invention is, therefore, indicated by the appended claims rather than by the foregoing description. All changes that come within the meaning and range of equivalency of the claims are to be embraced within their scope.

What is claimed is:

1. A multi-cavity optical device comprising:
a first Fabry-Perot structure having a first reflector a first spacer and a second reflector optically coupled to
a second Fabry-Perot structure having a third reflector, a second spacer, and a fourth reflector, wherein the first spacer includes an active material capable of changing an optical thickness of the first spacer upon application of a control signal to the active material.

2. The multi-cavity optical device of claim 1 wherein the control signal in an electronic potential applied across at least a portion of the active material.

3. The multi-cavity optical device of claim 1 wherein the control signal is a light signal applied to at least a portion of the active material.

4. The multi-cavity optical device of claim 1 further comprising an optical input wherein the first Fabry-Perot structure is proximate to the optical input.

5. The multi-cavity optical device of claim 1 further comprising an optical output wherein the first Fabry-Perot structure is proximate to the optical output.

6. The multi-cavity optical device of claim 1 further comprising a third Fabry-Perot structure.

7. The multi-cavity optical device of claim 6 comprising an even number of Fabry-Perot structures.

8. The multi-cavity optical device of claim 1 further comprising a third Fabry-Perot structure, a fourth Fabry-Perot structure, and a fifth Fabry-Perot structure,
wherein the first Fabry-Perot structure is proximate to an optical input or to an optical output of the multi-cavity optical device.

9. The multi-cavity optical device of claim 1, wherein the first reflector includes an at least partially transparent electrically conductive material.

10. The multi-cavity optical device of claim 9 wherein the at least partially transparent electrically conductive material is selected from the group consisting of indium oxide, indium tin oxide, erbium doped silicon dioxide, and combinations thereof.

11. The multi-cavity optical device of claim 9 wherein the second reflector includes a second at least partially transparent electrically conductive material.

12. The multi-cavity optical device of claim 5 wherein the first spacer includes an air gap and the active material lies outside an optical path through the multi-cavity optical device.

13. A multi-cavity optical device, comprising:
a first Fabry-Perot structure including
a first reflector optically coupled to a first optical port of the multi-cavity optical device;
a first spacer proximate to and coupled to the first reflector and having an optical thickness, the first spacer including an active material capable of changing the optical thickness of the first spacer in response to a control signal;
a second reflector optically coupled to the first spacer;
a second Fabry-Perot structure disposed between and optically coupled to the first Fabry-Perot structure; and
a third Fabry-Perot structure disposed between and optically coupled to the second Fabry-Perot structure and a second optical port of the multi-cavity optical device.

14. A method of attenuating an optical signal, the method comprising:
providing an optical signal to a multi-cavity optical device having a first spacer region and a second spacer region, the first spacer region including an active material and the first spacer having an initial optical thickness;
applying a control signal to the active material; and
changing the initial optical thickness to a second optical thickness.

15. The method of claim 14 wherein the changing step includes increasing the initial optical thickness to the second optical thickness.

16. The method of claim 14 wherein the changing step includes decreasing the initial optical thickness to the second optical thickness.

17. The method of claim 14 further comprising steps of:
applying a second control signal to the active spacer material; and
changing the second optical thickness to a third optical thickness.

18. The method of claim 14 wherein the initial optical thickness provides a first transmittance of between about 85-95% through the multi-cavity optical device and the second optical thickness provides a second transmittance of less than about 1% through the multi-cavity optical device.

19. The method of claim 14 wherein the initial optical thickness provides a first transmittance of between about 90-95% through the multi-cavity optical device and the second optical thickness provides a second transmittance of less than about 1% through the multi-cavity optical device.

20. The method of claim 18 wherein the second transmittance varies in proportion to the control signal.

21. A method of switching a multi-cavity optical switch, the method comprising:
providing an optical signal to an input of the multi-cavity optical switch having a first spacer region and a second spacer region, the first spacer region including an active material and the first spacer having an initial optical thickness;
transmitting the optical signal from the input of the multi-cavity optical switch to an output of the multi-cavity optical switch;
applying a control signal to the active material;
changing the initial optical thickness to a second optical thickness; and
reflecting the optical signal off of the multi-cavity optical switch.

22. The method of claim 21 wherein the multi-cavity device is a narrow-band filter device with a relative transmission bandwidth of about 0.04% or less.

23. The method of claim 21 wherein the multi-cavity optical device has an odd number of Fabry-Perot structures and the first spacer is in a Fabry-Perot structure proximate to the input or to the output.

24. The method of claim 21 further comprising steps of:
removing the control signal; and
transmitting the optical signal through the multi-cavity optical switch.
